(19) United States
(12) Patent Application Publication
(10) Pub. No.: US 2007/0115790 A1
(43) Pub. Date: May 24, 2007

(54) Holographic recording medium and holographic recording process using the same

(75) Inventors: Katsunori Kawano, Kanagawa (JP); Koichi Haga, Kanagawa (JP); Jiro Minabe, Kanagawa (JP); Yasuhiro Ogasawara, Kanagawa (JP); Shin Yasuda, Kanagawa (JP); Kazuhiro Hayashi, Kanagawa (JP); Hisae Yoshizawa, Kanagawa (JP); Makoto Furuki, Kanagawa (JP)

Correspondence Address: OLIFF & BERRIDGE, PLC, P.O. BOX 19928, ALEXANDRIA, VA, 22320, US

(73) Assignee: FUJI XEROX CO., LTD., Tokyo (JP)

(21) Appl. No.: 11/477,365

(22) Filed: Jun. 30, 2006

(30) Foreign Application Priority Data
Nov. 21, 2005 (JP) 2005-336351

(51) Int. Cl. G11B 7/00

(52) U.S. Cl. 369/103

(57) ABSTRACT

According to an aspect of the invention, there is provided a holographic recording medium including a recording layer in which information is recorded by irradiating a signal light and a reference light simultaneously to the layer, and a reflecting track on which a servo signal light is reflected, the reflecting track being formed on or above a recording layer surface to which the signal light is irradiated.

### CROSS-REFERENCE TO RELATED APPLICATION

This application claims priority under 35 USC 119 from Japanese Patent Application No. 2005-336351, the disclosure of which is incorporated by reference herein.

### BACKGROUND

1. Technical Field

The present invention relates to a holographic recording medium, and a holographic recording process using the same.

2. Related Art

Holographic recording, which uses holography to record information in a recording medium, is performed by irradiating a signal light and a reference light to the recording medium and writing interference fringes formed at this time in the recording medium. One of the recording media used for such holographic recording is a reflective recording medium, wherein a servo pit pattern is formed on a surface of a substrate and a reflective layer and a recording layer are formed thereon in this order.

However, in the reflective recording medium, the reflective surface of the reflective layer is not completely flat since the servo pit pattern is formed on the substrate surface. For this reason, light irradiated at the time of recording or reproducing information is irregularly reflected on the reflective layer, resulting in the generation of noise.

In order to prevent such irregular reflection on a reflective layer of a recording medium to reduce the amount of noise superposed on reproduced images, there is suggested a recording medium including a transparent substrate, a recording layer, and a filter layer (wavelength-selecting layer) which is formed between the transparent substrate and the recording layer, transmits light having a first wavelength (servo light), and reflects light having a second wavelength (light used to record or reproduce information). This recording medium can transmit the servo light necessary for servo control by the action of the filter layer while the medium reflects the light necessary for the recording or reproduction of information. Consequently, the generation of noise as described above can be restrained.

However, this technique requires a light source that is exclusively for servo control to be separately used. Thus, the technique has a drawback in that costs for a recording and reproducing apparatus are increased. Additionally, it is necessary to form the wavelength-selecting layer in the recording medium in order to decrease noise resulting from irregular reflection on the reflective layer, whereby the costs of manufacturing the recording media are increased.

### SUMMARY

According to an aspect of the invention, there is provided a holographic recording medium including a recording layer in which information is recorded by irradiating a signal light and a reference light simultaneously to the layer, and a reflecting track on which a servo signal light is reflected, the reflecting track being formed on or above a recording layer surface to which the signal light is irradiated.

### BRIEF DESCRIPTION OF THE DRAWINGS

Embodiments of the present invention will be described in detail based on the following figures, wherein:

FIG. 1 is a schematic sectional view illustrating an example of the recording medium of the present invention;

FIG. 2 is a schematic sectional view illustrating another example of the recording medium of the invention.;

FIG. 3 is a schematic view illustrating the shape of a reflecting track in the recording medium of the invention; and

FIG. 4 is a schematic view illustrating an example of a recording and reproducing apparatus used in the holographic recording process of the invention.

### DETAILED DESCRIPTION

The holographic recording medium (sometimes referred to hereinafter as the recording medium) according to the present invention is a holographic recording medium including a recording layer in which information is recorded by irradiating a signal light and a reference light simultaneously to the layer, and a reflecting track on which a servo signal light is reflected, the reflecting track being formed on or above a recording layer surface to which the signal light is irradiated.

In the recording medium of the invention, the reflecting track is formed on or above a recording layer surface to which a signal light is irradiated. Accordingly, when the signal light is irradiated in such a manner that a zero order light component of the signal light corresponds substantially to the reflecting surface of this reflecting track at the time of recording and/or reproducing information, servo control can be attained by using the zero order light component of the signal light reflected on the reflecting track as a servo signal light. It is therefore possible to make a light source that is exclusively for servo control unnecessary.

In a case where the recording medium of the invention has a structure wherein a reflective layer is further formed on or above a recording layer surface opposite to the recording layer surface to which a signal light is irradiated (a reflective recording medium), it is unnecessary to form a servo pit pattern in a surface of a substrate or the like. It is therefore possible to make the reflecting surface of the reflective layer flat. For this reason, irregular reflection, which generates noise, is not generated on the reflective layer. Thus, it is unnecessary to form a wavelength-selecting layer in order to prevent irregular reflection.

In a case where the recording medium of the invention is a reflective recording medium wherein a zero order light component of a signal light is used as a servo signal light to record or reproduce information, the structure of a recording and reproducing apparatus therefor can be made simpler. For example, an optical system such as is used for recording or reproduction in an optical disc such as a DVD (what is called an infinite optical system) can be used.

Meanwhile, it is an important task to attain a high recording density in holographic recording. For example, Japanese Patent Application Laid-Open (JP-A) No. 2000-66566 suggests the following process in order to restrain omissions of data and record or reproduce image edge portions (portions wherein zero order components are removed) of a signal light at high density: a process for performing recording or reproduction in a state in which, between a recording medium and a light source for irradiating the signal light to this recording medium, a light-shielding body is arranged in which a zero order light component of the signal light is shielded and a light transmitting section which transmits a spatial frequency component in at least one direction of the signal light is partially formed.

In the process using such a light-shielding body, not only alignment between two things (the optical axis of the signal light and the recording medium) but alignment between three things (the light-shielding body, the optical axis of the signal light and the recording medium) is required. Accordingly, high precision is required.

In the invention, however, information can be recorded or reproduced at high density without using any light-shielding body since a signal light in which a zero order light component is removed (higher-order light components) is irradiated to the recording layer around the reflecting track.

Structure of the Holographic Recording Medium

Next, the structure of the recording medium of the invention and materials used therefor will be described in detail.

In the recording medium of the invention, the recording layer may be formed on a substrate (or a base plate).

In this case, the recording medium may be a reflective recording medium wherein a reflective layer is formed between the recording layer and the substrate, or a transmission type recording medium wherein no reflective layer is formed. In the case of the reflective recording medium, the medium may be a two-sided recording medium wherein a reflective layer and a recording layer are formed on both sides of a substrate. In the case of the transmission type recording medium, the substrate may be a substrate made of a material having transmittance with respect to at least a reference light.

A protective layer for protecting the recording layer may be provided on a recording layer surface opposite to the recording layer surface on which the substrate is provided. The protective layer may serve as a substrate (that is, a structure wherein a recording layer is between a pair of substrates). If desired, an intermediate layer may also be provided for the purpose of ensuring adhesion between the substrate and the reflective layer or the recording layer, or ensuring adhesion between the reflective layer, the recording layer and the protective layer.

In any one of these layer structures of the recording medium, a reflecting track is formed on or above a recording layer surface to which the signal light is irradiated.

For example, in the case of a reflective recording medium wherein a reflective layer, a recording layer, and a protective layer are formed, in this order, on a substrate, a reflecting track may be formed at an interface between the recording layer and the protective layer, on the surface of the protective layer, or inside the protective layer. In the case of a transmission type recording medium wherein a recording layer and a protective layer are formed, in this order, on a substrate and a signal light is irradiated to the recording medium surface on which the protective layer is formed at the time of recording or reproducing information, a reflecting track may be formed at an interface between the recording layer and the protective layer, on the surface of the protective layer, or inside the protective layer.

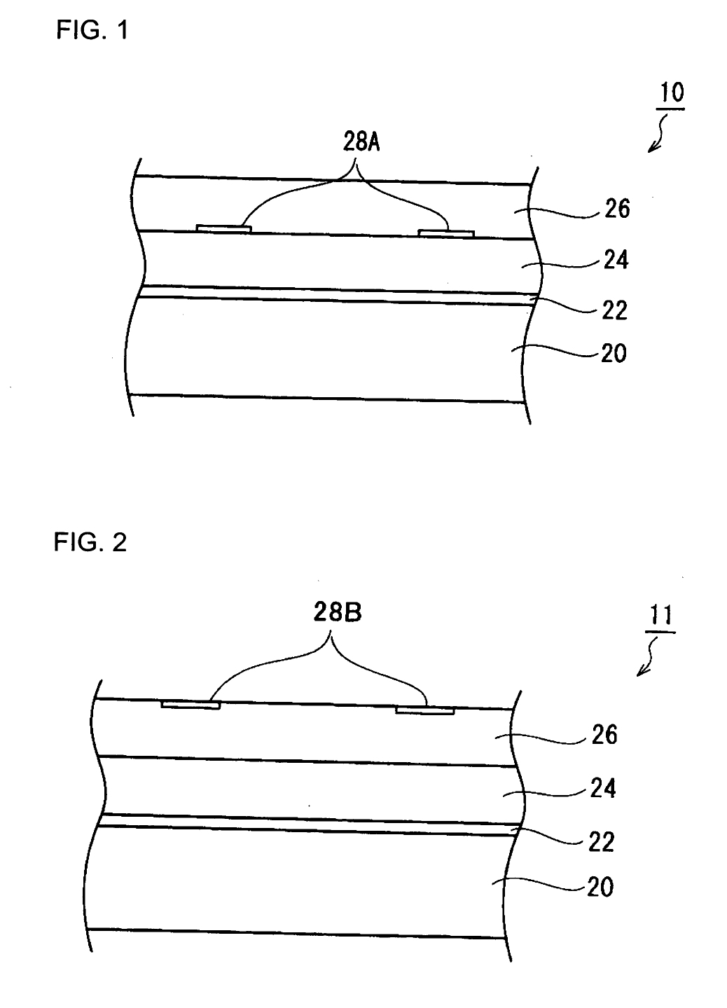

FIGS. 1 and 2 are each a schematic sectional view illustrating an example of the recording medium of the invention. In FIGS. 1 and 2, reference numbers 10 and 11 each represent a recording medium; 20 represents a substrate; 22 represents a reflective layer; 24 represents a recording layer; 26 represents a protective layer; and 28A and 28B represent reflecting tracks.

The recording medium 10 illustrated in FIG. 1 has a structure wherein the reflective layer 22, the recording layer 24, and the protective layer 26 are laminated, in this order, on one surface of the substrate 20, and the reflecting track 28A is arranged at an interface between the recording layer 24 and the protective layer 26. A signal light is irradiated to the recording medium 10 at a side at which the protective layer 26 is formed. The recording medium 11 illustrated in FIG. 2 has a structure wherein the reflective layer 22, the recording layer 24 and the protective layer 26 are laminated, in this order, on one surface of the substrate 20, and the reflecting track 28B is arranged on the surface of the protective layer 26. A signal light is irradiated to the recording medium 11 at a side at which the protective layer 26 is formed.

The holographic recording medium may be in any selected shape such as a disc shape, a sheet shape, a tape shape, and a drum shape, as long as the recording layer is two-dimensionally formed with a constant thickness.

However, a disc shape having a hole at its center (as used for conventional optical recording media) may be applicable, because existing manufacturing technology for optical recording media and existing recording/reproduction systems can easily be applied.

(Recording Layer)

For the recording layer, a known recording material for holographic recording can be used, which is capable of recording or reproducing information by irradiation with light. For example, the following is used: a material which has a transmittance or refractive index variable when irradiated with light, a material variable in irregularity by shrinkage or expansion of the volume thereof, or some other materials.

A photorefractive material wherein the refractive index can be changed by irradiation with light may be used from the viewpoint of flexibility of material-selection, and others. An organic photorefractive material may be used since the material is easily made into any shape and the sensitive wavelength thereof is easily adjusted.

The thickness of the recording layer may be from 3 μm to 2 mm from a practical viewpoint. The thickness may be within the ranges as described below in accordance with the type of the holographic recording medium which is decided by relationship between the interval between interference fringes recorded in the recording layer and the thickness of the recording layer.

In a case where the holographic recording medium of the invention is for a plane hologram (in a case where the thickness of the recording layer is not more than the interval between interference fringes recorded in the recording layer), the thickness may be from 3 to 100 μm, or from 5 to 20 μm.

In a case where the holographic recording medium of the invention is for a volume hologram (in a case where the thickness of the recording layer is not less than but at most several times larger than the interval between interference fringes recorded in the recording layer), the thickness may be from 100 μm to 2 mm, or from 250 μm to 1 mm.

<Photorefractive Material>

The photorefractive material for use in the holographic recording medium of the invention is described in detail below. The photorefractive material for use in the holographic recording medium of the invention may be any known material that changes its refractive index when light is irradiated to it.

For example, an inorganic photorefractive material may be used, including an inorganic ferroelectric crystal material such as barium titanate, lithium niobate and bismuth silicate. In terms of easiness of shaping and easiness of control of sensitive wavelength, an organic photorefractive material may be used. In the invention, a macromolecular or low-molecular material having a photoisomerizable group may be used, which needs no outer electric field for a change in refractive index.

A relatively inexpensive semiconductor laser can be used as the light source, and it can be used in combination with any other optical device or the like. Thus, the light for use in recording/reproduction may have a wavelength of 350 to 800 nm, or a wavelength of 400 to 650 nm. Therefore, the photorefractive material for use in the invention may be a material that changes its refractive index in response to a wavelength in such a range.

The organic photorefractive material for use in the invention is described in more detail below.

The organic photorefractive material may be an organic material that has a partial structure capable of causing isomerization (such as cis-trans isomerism and syn-anti isomerism) by the irradiattion of light and causes a change in refractive index by the isomerization of the partial structure.

In the invention, the photorefractive material may have an azobenzene structure (a structure including an azo group and benzene rings provided at both ends of the azo group) capable of causing cis-trans isomerization by the irradiation of light. Such cis-trans isomerization of an azobenzene structure is shown as Isomerization Example 1 below.

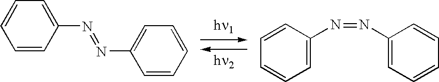

### ISOMERIZATION EXAMPLE 1

In the case of a photorefractive polymer material, the photoisomerizable group (which refers to a group that causes an isomerization reaction by the irradiation of light) having an azobenzene structure or the like may be contained in its side chain moiety. Such a polymer material molecule can be designed in various ways with respect to its main and side chain structures, respectively, and thus has a merit that not only its absorption coefficient but also its various physical properties necessary for holographic recording, such as its sensitive wavelength range, its speed of response and its record retention properties can easily be controlled to the desired values at a high level. In addition to the photoisomerizable group, for example, a liquid-crystalline linear mesogen group such as a biphenyl derivative may be introduced into the side chain. In such a case, the change in the orientation of the photoisomerizable group by the irradiation of light can be enhanced or fixed so that the loss in absorption can be suppressed.

Examples of the polymer material having the azobenzene structure or the like include the polymer materials disclosed in Japanese Patent Application Nos. 2004-150801, 2004-113463, 2004-163889, 2004-83716, 2004-81670, 2004-135949, 2004-135950, and 2004-81610, the disclosures of which are incorporated by reference herein.

As one example of the photorefractive material usable in the invention, one example of a structural formula of a polymer having a photoisomerizable group having an azobenzene structure in its side chain moiety (hereinafter, referred to as “azopolymer (1)” in some cases) is described below. In the structural formula, n represents an integer of 1 or more.

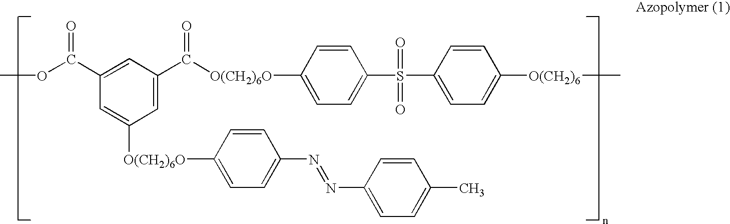

Besides the azobenzene structure-containing materials, diarylethene type materials may be used as the photorefractive material. Diarylethenes can exhibit photochromism. Such photochromism is a 6π-electron ring reaction in which the conversion is caused only by light similarly to fulgide or the like. Diarylethenes may be classified as a type of stilbene. The photochromism of the diarylethenes is cis-trans isomerization and characterized in that its thermal stability and repeat durability are high. The chemical structural formula of a typical diarylethene and an example of its isomerization reaction (Isomerization Example 2) are shown below.

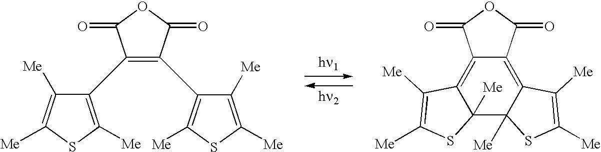

### ISOMERIZATION EXAMPLE 2

For example, the holographic recording medium may have a recording layer including a dispersion of diarylethene in polyvinyl alcohol (PVA), polymethylmethacrylate (PMMA) or the like. The recording layer of this holographic recording medium becomes colorless by the irradiation of light of about 500 nm in wavelength and forms color by the irradiation of light of about 360 nm in wavelength. Holographic recording can be performed using such a change in absorption.

Spiropyran type materials may also be used as the photorefractive material. Spiropyrans are the mostly researched and reported photochromic compounds. Some of the spiropyrans are in the actual use, and the spiropyrans are one of the most promising compounds. The chemical structural formula of a typical spiropyran and an example of its isomerization reaction (Isomerization Example 3) are shown below.

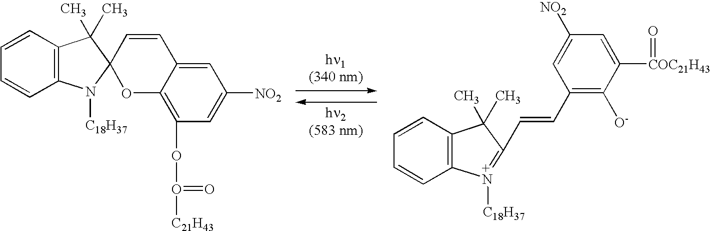

### ISOMERIZATION EXAMPLE 3

Spiropyrans shows a blue color by the irradiation of light and can produce good contrast. Spiropyran-containing polymer materials are typically characterized in that: ultraviolet light can turn them from colorless to colored; the coloring speed is high; and the color is slowly fading when they are allowed to stand in a dark place. The spiropyrans with such characteristics may be used as the photorefractive material for the holographic recording medium of the invention.

Other examples thereof include xanthene dyes such as uranine, Erythrosine B and Eosine Y. The chemical structural formula of a typical xanthene dye, uranine, and an example of its isomerization reaction (Isomerization Example 4) are shown below. If a xanthene dye is used, recording of information on a holographic recording medium can be performed even with a relatively low-intensity light beam. When the holographic recording medium is produced with the xanthene dye, a dispersion of the xanthene dye in PVA, PMMA or the like may be used.

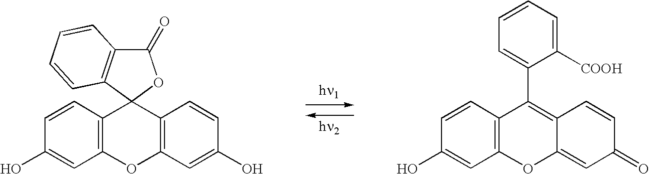

### ISOMERIZATION EXAMPLE 4

Fulgide type materials may also be used as the photorefractive material. The chemical structural formula of a typical fulgide and an example of its isomerization reaction (Isomerization Example 5) are shown below. Fulgide forms color by the irradiation of ultraviolet light with a wavelength of 365 nm and is isomerized by the irradiation of green light with a wavelength of 515 nm or 532 nm. Thus, such characteristics may be applied to the holographic recording medium.

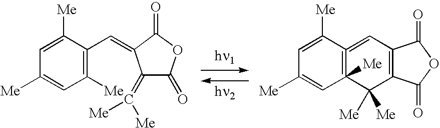

### ISOMERIZATION EXAMPLE 5

Photochromic compound-containing polymer materials other than the azobenzene structure-bearing materials may also be used as the photorefractive material in the invention. Examples of such other materials include the materials disclosed in Japanese Patent Application No. 2004-81666, the disclosure of which is incorporated by reference herein. Examples of other photorefractive materials include the materials disclosed in Japanese Patent Application Nos. 2003-298936, 2003-300059, 2003-300057, 2004-88790, and 2004-91983, the disclosures of which are incorporated by reference herein.

Other Components (Binder and Others)

If necessary, other components such as a binder resin may be used in the recording layer.

Polymethylmethacrylate (PMMA) having good optical properties or polyvinyl alcohol (PVA) may be used as the binder resin. The polyester material having cyanobiphenyl in its side chain, as represented by Structural Formula (1) below, may also be used as the binder resin.

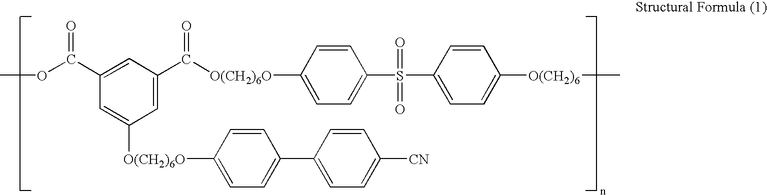

In the structural formula (1), n represents an integer of 1 or more. This polyester material has transparency in the wavelength range of light generally used for recording/reproducing information on/from a holographic recording medium. This polyester material may be used in combination with the photoresponsive polymer having a photoisomerizable group. In such a case, birefringence can be induced by the isomerization of the photoisomerizable group, and therefore, the sensitivity of the photoresponsive polymer can effectively be increased. The term “combination” refers to not only physical mixing of the photoresponsive polymer having the photoisomerizable group and the polyester represented by Structural Formula (1) but also chemical mixing of them, that is, a case where the repeating unit represented by Structural Formula (1) is contained in the photoresponsive polymer having the photoisomerizable group (to form a copolymer).

Formation of the Recording Layer

In order to form the recording layer, a known method can be appropriately used in accordance with a material used as the material for the recording layer. For example, the following method can be used: a liquid phase method of using a coating solution in which the material constituting the recording layer is dissolved, such as spraying, spin coating, dipping, roll coating, blade coating, doctor rolling, or screen printing method; vapor deposition; or the like.

(Substrate/Base Plate)

Any material may be selected and used as the substrate or the base plate, as long as it has a smooth surface. For example, metals, ceramics, resins, paper, and the like may be used. It may also be in any shape. A disc-shaped flat substrate having a hole at its center (as used for conventional optical recording media) may be used, because existing manufacturing technology for optical recording media and existing recording/reproduction systems can easily be applied.

Examples of materials for such a substrate include glass, polycarbonate, acrylic resin such as polymethylmethacrylate, vinyl chloride resin such as polyvinyl chloride and vinyl chloride copolymer, epoxy resin, amorphous polyolefin, polyester, and metals such as aluminum. If desired, any of these materials may be used in combination.

In terms of resistance to moisture, dimensional stability and low cost, amorphous polyolefin and polycarbonate may be used, or polycarbonate may be used.

In general, on a surface of a substrate are formed guide grooves for tracking or irregularities (pregroove) representing information such as address signals. In the invention, a reflecting track is formed on or above a recording layer surface to which a signal light is irradiated; therefore, it is unnecessary to form such a pregroove except a case where a substrate is provided on or above a recording layer surface to which a signal light is irradiated.

In a case where light for recording or reproduction will be irradiated to the recording layer through a substrate, the substrate should transmit light in the range of the wavelength of the irradiated light (a recording light and a reproducing light). In this case, the transmittance may be 90% or more in the range of the wavelength of the irradiated light (around the wavelength having a maximum intensity in the case of a laser beam).

In the process of forming a reflective layer on the substrate surface, an undercoat layer may be formed on the substrate surface for the purpose of improving flatness and adhesion strength.

Examples of the material for the undercoat layer include a polymer material such as polymethylmethacrylate, acrylic acid-methacrylic acid copolymer, styrene-maleic anhydride copolymer, polyvinyl alcohol, N-methylolacrylamide, styrene-vinyl toluene copolymer, chlorosulfonated polyethylene, nitrocellulose, polyvinyl chloride, chlorinated polyolefin, polyester, polyimide, vinyl acetate-vinyl chloride copolymer, ethylene-vinyl acetate copolymer, polyethylene, polypropylene, polycarbonate; and a surface modifying agent such as a silane coupling agent.

The undercoat layer may be formed by a process including the steps of dissolving or dispersing any of the above materials in an appropriate solvent to prepare a coating liquid and applying the coating liquid to the substrate surface by such a coating method as spin coating, dip coating and extrusion coating. In general, the thickness of the undercoat layer may be from 0.005 μm to 20 μm, or from 0.01 μm to 10 μm.

(Reflective Layer)

The reflective layer may be made of a light-reflecting material having a reflectance of at least 70% with respect to a laser beam. Examples of such a light-reflecting material include metals and semimetals such as Mg, Se, Y, Ti, Zr, Hf, V, Nb, Ta, Cr, Mo, W, Mn, Re, Fe, Co, Ni, Ru, Rh, Pd, Ir, Pt, Cu, Ag, Au, Zn, Cd, Al, Ga, In, Si, Ge, Te, Pb, Po, Sn, and Bi; and stainless steels.

One of these light-reflecting materials may be used alone, or two or more of these materials may be combined and used, for example in the form of an alloy. Cr, Ni, Pt, Cu, Ag, Au, Al, and stainless steels; Au, Ag, Al, and any alloy thereof; or Au, Ag and any alloy thereof may be used.

For example, the reflective layer may be formed on the substrate by vapor deposition, sputtering or ion-plating of any of the above light-reflecting materials. In general, the thickness of the reflective layer may be from 10 nm to 300 nm, or from 50 nm to 200 nm.

(Protective Layer)

Any known material may be used to form the protective layer, as long as it has a thickness and is made of a material so as to protect the recording layer mechanically, physically and chemically under normal use conditions. For example, a transparent resin or a transparent inorganic material such as Sio₂ may be used for the protective layer.

In a case where light for recording or reproduction is irradiated to the recording layer through a protective layer, the protective layer should be made of a material that transmits light in the range of the wavelength of the irradiated light. In this case, the transmittance may be 90% or more with respect to the range of the wavelength of the irradiated light (around the wavelength having a maximum intensity in the case of a laser beam). The same applies to an intermediate layer which may be provided on or above the recording layer surface to which light is irradiated for the purpose of improving adhesion or the like.

The protective layer may be made of a resin. In such a case, a resin film including polycarbonate or cellulose triacetate previously shaped into a sheet may be used and bonded onto the recording layer to form the protective layer. The bonding process may include the steps of bonding the film with a thermosetting or UV-curable adhesive for ensuring adhesion strength and curing the adhesive by heat treatment or UV irradiation. While the resin film for use as the protective layer may have any thickness as long as it can protect the recording layer, it may have a thickness of 30 μm to 200 μm, or 50 μm to 150 μm, in terms of practical use.

Alternatively, a thermoplastic resin, a thermosetting resin, or a photo-setting resin may be applied in place of the resin film in order to form the protective layer.

The protective layer may be made of a transparent ceramic material such as SiO₂, MgF₂, SnO₂, and Si₃N₄ or a glass material. In such a case, the protective layer may be formed by a sputtering method or a sol-gel method. While the protective layer of the transparent inorganic material may have any thickness as long as it can protect the recording layer, it may have a thickness of 0.1 μm to 100 μm, or 1 μm to 20 μm, in terms of practical use.

(Reflecting Track)

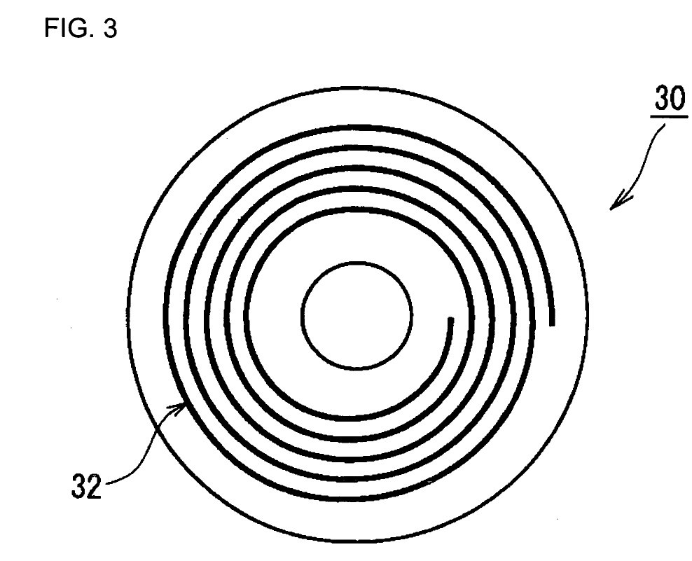

The reflecting track can be formed by vapor deposition, sputtering, ion plating or the like, using the same material as used for the reflective layer. The shape of the reflecting track in the plane direction of the recording medium is not particularly limited, and may be the same as in the prior art. An example thereof is a shape illustrated in FIG. 3, which is a schematic view illustrating the shape of a reflecting track in a recording medium of the invention, and illustrates the shape of the reflecting track in the plane direction of the recording medium. In FIG. 3, reference numbers 30 and 32 represent the recording medium and the reflecting track, respectively.

It is allowable to form the reflecting track directly on the surface of a layer, or to form a guide groove on the layer surface and then form the reflecting track in the groove. The reflecting surface of the reflecting track may be arranged so as to be perpendicular to the incident direction of a signal light.

(Process for Producing the Recording Medium)

A description is provided below of a process for producing the holographic recording medium configured as described above according to the invention.

The holographic recording medium for plane hologram according to the invention may be manufactured by sequentially laminating the recording layer and any other layer on the substrate depending on the material for each layer.

For example, a brief description is provided below of the main flow of a process of manufacturing the holographic recording medium including a recording layer and a protective layer each provided on a substrate. First, a coating solution of a photorefractive polymer material in a solvent is used to form a recording layer with the desired thickness on a polycarbonate substrate through a spin coating method, and sufficiently dried. Next, a UV-curable adhesive is uniformly applied to the recording layer by a spin coating method, and then the recording layer is bonded to a cellulose triacetate resin film for forming a protective layer. UV light is then applied to solidify the adhesive, so that a holographic recording medium can be obtained which includes a structure of the protective layer/the recording layer/the substrate.

For example, a reflecting track may be formed on the surface of the recording layer (or on the protective layer surface which is to be stuck onto the recording layer) by Al vapor deposition or the like after the recording layer is formed but before the recording layer and the protective layer are stuck onto each other, or may be formed on the surface of the protective layer in the same manner after the recording layer and the protective layer are stuck onto each other.

In a case where the holographic recording medium of the invention is for a volume hologram, its recording layer can be formed by injection molding and hot press. Specifically, the holographic recording medium can be produced as follows.

In a case where injection molding is used, the holographic recording medium may be manufactured as follows. First, injection molding is performed to form a disc-shaped material for use as a recording layer. The disc-shaped material is then sandwiched between a pair of disc-shaped transparent substrates, and they are laminated by hot press and bonded with a hot melt adhesive.

In the process of injection molding, a starting material resin (a resin containing at least a photorefractive material) is heated and melted, and the melted resin is injected into a molding die and molded into the form of a disc. The injection molding machine may be any of an inline type injection molder having a material-plasticizing function and an injection function integrated with each other and a pre-plunger type injection molder having a plasticizing function and a injection function separated from each other. The injection molding may be performed under the conditions of an injection pressure of 1000 to 3000 kg/cm² and an injection speed of 5 to 30 mm/sec.

In the hot press process, the plate-shaped material produced by the injection molding process is sandwiched between a pair of transparent disc-shaped substrates, and they are hot-pressed under vacuum.

In the holographic recording medium prepared as described above, the recording layer is not a film formed on the substrate but a film separately formed by injection molding. Such a recording layer can easily be made thick, and such a holographic recording medium is suited for mass production. In addition, the residual strain of the injection-molded material is made uniform in the process of laminating the recording layer and the transparent substrate by hot press. Even if a thick recording layer is produced, therefore, the recording characteristics will not be degraded by the effect of light absorption or scattering.

The reflecting track may be formed on the surface (i.e., the surface to which a signal light is irradiated in the medium) of the plate-shaped molded product (i.e., the recording layer) obtained by the injection molding process by Al vapor deposition or the like. In a case where a signal light is irradiated to the recording medium at a side where the transparent substrate is formed, the reflecting track may be formed in the same manner at the transparent substrate side of the recording medium.

In a case where hot press is used, for example, the holographic recording medium may be prepared as follows. A powdered resin (a resin containing at least a photorefractive material) is sandwiched between highly-releasable substrates (pressing members) such as Teflon® sheets and hot-pressed under vacuum in this state to form a recording layer directly.

In the hot press process, vacuum hot press may be performed. In such a case, a powdered resin material is packed between a pair of pressing members. The pressure is then reduced to about 0.1 MPa for the purpose of preventing bubbles from forming, while the material is gradually heated to a specific temperature and pressed through the pressing members. In this process, the heating temperature may be at least the glass transition temperature (Tg) of the resin material, and the pressing pressure may be from 0.01 to 0.1 t/cm². After the hot press is performed for a given time period, the heating and the pressing are stopped, and the material is cooled to room temperature and then taken out.

When the hot press is performed, the resin material sandwiched between the pair of pressing members is heated and melted, and the melt is cooled to form a plate-shaped recording layer. Finally, the pressing members are removed so that an optical recording medium is obtained. For example, when the recording layer is produced with an azopolymer, which has a low Tg of about 50° C., the polymer is heated to about 70° C. and hot-pressed so that the recording layer can easily be formed with the desired thickness. The hot press does not cause residual strain.

If desired, a protective layer or the like may be formed for the purpose of increasing the damage or humidity resistance of the holographic recording medium including this recording layer.

In the holographic recording medium prepared as described above, the recording layer is not a film formed on the substrate but a film separately formed by hot press. Such a recording layer can easily be made thick. In addition, the recording layer shaped by hot press can be free from residual strain or the like. Even if a thick recording layer is produced, therefore, the recording characteristics will not be degraded by the effect of light absorption or scattering.

The reflecting track can be formed, for example, by Al vapor deposition on the surface (the surface to which a signal light is irradiated in the medium) of the plate-shaped recording layer obtained after the hot press.

<Holographic Recording Process>

Next, the holographic recording process using the holographic recording medium of the invention will be described. At the time of recording in the holographic recording process of the invention, a known process of irradiating a signal light and a reference light simultaneously onto the same area in the recording layer to record information can be used. At the time of reproduction, a known process of irradiating a reference light onto the area in the recording layer where the information is recorded so as to obtain reproducing light (readout information) can be used.

In the holographic recording process of the invention, the optical axis of the signal light and that of the reference light may be perpendicular to the reflecting surface of the reflecting track and be coaxially positioned, and a zero order light component of the signal light may be used as the servo signal light.

In this case, the optical axis of a light irradiated to the recording layer and that of a light reflected on the reflecting track are positioned on the same axis. It is therefore unnecessary to arrange optical members such as a lens or optical elements for each optical axis of lights having different functions or roles. Accordingly, information can be recorded on the holographic recording medium and/or the recorded information can be reproduced therefrom by means of a recording and reproducing apparatus that is simpler than apparatuses in the prior art. Thus, in the invention, a recording and reproducing apparatus in which an infinite optical system for an optical disc such as a DVD is adopted may be used.

Furthermore, when a reflective recording medium is used as the recording medium, the detection of a reproducing light and a servo signal light which is reflected on the reflecting track can be attained by only one light receiving element. Thus, the structure of the recording and reproducing apparatus can be made even simpler.

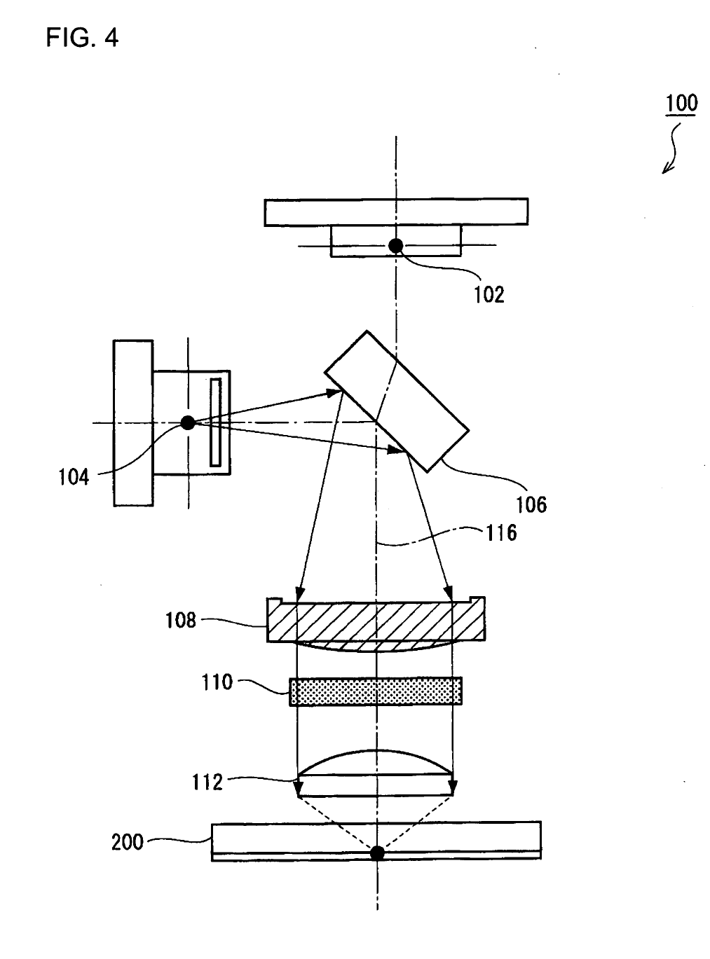

FIG. 4 is a schematic view illustrating an example of a recording and reproducing apparatus used in the holographic recording process of the invention, and illustrates a recording and reproducing apparatus wherein an infinite optical system using a reflective recording medium as illustrated in FIG. 1 or 2 is adopted.

In FIG. 4, reference number 100 represents the recording and reproducing apparatus; 102 represents a light receiving element; 104 represents a light source; 106 represents a half mirror; 108 represents a parallel light correcting lens; 110 represents a spatial light modulator; 112 represents an objective lens; 116 represents an optical axis; and 200 represents a reflective recording medium.

The recording and reproducing apparatus 100 illustrated in FIG. 4 is composed of the light source 104 such as a laser diode, the half mirror 106 arranged so that its reflecting surface is directed obliquely toward a direction in which light from the light source 104 is to be irradiated, the parallel light correcting lens 108 arranged at the reflecting surface side of the half mirror 106 and on the optical axis 116 of the light which is irradiated from the light source 104 and then reflected on the half mirror 106, the spatial light modulator 110, the objective lens 112, and the light receiving element 102, such as a CCD, arranged at a side of the half mirror 106 opposite to the reflecting surface side thereof and on the optical axis 116. The parallel light correcting lens 108, the spatial light modulator 110 and the objective lens 112 are arranged in this order from the reflecting surface side of the half mirror 106.

At the time of recording or reproducing information, the reflective recording medium 200 is arranged at a side of the objective lens 112 opposite to the side thereof where the spatial light modulator 110 is arranged in such a manner that the objective lens 112 is focused on the recording layer (not illustrated in the figure) and the optical axis 116 is perpendicular to the surface of the recording layer.

Information is recorded or reproduced as follows: light irradiated from the light source 104 is reflected on the half mirror 106 toward the reflective recording medium 200, and is passed through the parallel light correcting lens 108, the spatial light modulator 110 and the objective lens 112 so as to be irradiated to the reflective recording medium 200.

Light irradiated from the light source 104 functions as both signal light and reference light. When the light passes through the spatial light modulator 110, light passing through the center portion of the modulator 110 is used as the signal light, and light passing through the peripheral portion of the modulator 110 is used as the reference light. Thus, the structure of the apparatus can be made simple since no light source that is exclusively for servo control is necessary. Accordingly, optical axis of the signal light and the reference light are present on the optical axis 116 in the figure. A zero order light component of the signal light is also present on the optical axis 116.

When light is irradiated from the light source 104, the zero order light component reflected on the reflecting track (not illustrated in the figure) of the reflective recording medium 200 passes through the objective lens 112, the spatial light modulator 110, the parallel light correcting lens 108, and the half mirror 106 so as to be irradiated to the light receiving element 102. Consequently, tracking information can be obtained by the light receiving element 102.

In a case where only reference light is irradiated, reproducing light also travels along the same route so as to be detected by the light receiving element 102, so that information can be reproduced. For this reason, the detections of the tracking information (the zero order light component reflected on the reflective recording medium 200) and the reproducing light can be attained by the same light receiving element. Thus, the structure of the apparatus can be made simple.

In the recording and reproducing process as illustrated in FIG. 4, signal light and servo signal light (a zero order light component of the signal light) are present together on the same optical axis; accordingly, the recording or reproduction of information and the detection of tracking information are performed in a time sharing manner.

At the time of recording information, the spatial light modulator 110 makes a display corresponding to the information to be recorded. At the time of tracking, the spatial light modulator 110 may make a white display at the whole surface.

In a reflecting track having a width in the diameter direction of a recording medium as illustrated in FIG. 3 (a reflective recording medium), the width d of the reflecting track may satisfy the following expression (1):
(1): λ/2≦d≦100λf/L
wherein d represents the width of the reflecting track, λ represents the wavelength of the light irradiated from the light source 104 (signal light), f represents the focal distance of the objective lens 112, and L represents the width of the spatial light modulator 110 in a direction perpendicular to the optical axis 116 of the signal light. More specifically, L corresponds to the length of each side of the square of a section of the spatial modulator 110 in a direction perpendicular to the optical axis 116 of the signal light.

If the expression (1) is not satisfied, it may be difficult to record information. If the width d of the reflecting track is less than λ/2, the zero order light leaks into the recording layer so that the SNR of the medium may be deteriorated.

If the width d of the reflecting track is more than 100λf/L, necessary Fourier frequency components of the signal light often cannot be irradiated to the recording layer, whereby the SNR may be deteriorated. In order to record a signal and read out the signal at a higher SNR, the upper limit of the width d of the reflecting track may be 10λf/L or less so that the Fourier spectrum of the signal light can be sufficiently irradiated to the recording layer.

The same advantageous effects obtained by satisfying the relational expression represented by the expression (1) can be obtained in the recording of information in not only an optical system as illustrated in FIG. 4 but also the following optical system in a case where a reflecting track is formed in the form of a belt in the plane direction of a recording layer as well as in a case where a reflecting track is formed in a spiral belt form, as illustrated in FIG. 3.

The expression (1) can be applied to an optical system including a light source that irradiates light, a spatial modulator that converts the light irradiated from the light source into at least the signal light, and an objective lens that converges and irradiates the signal light formed by the conversion through the spatial modulator so as to focus on the recording layer, wherein the spatial modulator and the objective lens are arranged in such a manner that the optical axis of the signal light at least between the objective lens and the recording layer is parallel to the thickness direction of the recording layer.

The present invention provides at least the following embodiments <1>to <4>.

<1> A holographic recording medium comprising a recording layer in which information is recorded by irradiating a signal light and a reference light simultaneously to the layer, and a reflecting track on which a servo signal light is reflected, the reflecting track being formed on or above a recording layer surface to which the signal light is irradiated.

As described above, in the recording medium of the invention, a reflecting track is formed on or above a recording layer surface to which a signal light is irradiated. Accordingly, when the signal light is irradiated in such a manner that a zero order light component of the signal light corresponds substantially to the reflecting surface of this reflecting track at the time of recording or reproducing information, the zero order light component of the signal light reflected on the reflecting track can be used as servo signal light, while information can be recorded in the recording layer around the reflecting track by components (high order light components) other than the zero order light component of the signal light.

In a case where the recording medium of the invention has a structure wherein a reflective layer is further formed on or above a recording layer surface opposite to the recording layer surface to which a signal light is irradiated (a reflective recording medium), it is unnecessary to form a servo pit pattern in a surface of a substrate, or the like. It is therefore possible to make the reflecting surface of the reflective layer flat. For this reason, even if light irradiated to record or reproduce information reaches the reflective layer, the light does not undergo irregular reflection on the reflective layer.

<2> The holographic recording medium of <1>, wherein:

the information is recorded by use of an optical system comprising a light source that irradiates light, a spatial modulator that converts the light irradiated from the light source into at least the signal light, and an objective lens that converges and irradiates the signal light formed by the conversion through the spatial modulator so as to focus on the recording layer;

the spatial modulator and the objective lens are arranged in such a manner that the optical axis of the signal light at least between the objective lens and the recording layer is parallel to the thickness direction of the recording layer;

the reflecting track is formed in the form of a belt along the plane direction of the recording layer; and

the following expression (1) is satisfied:
(1): λ/2≦d≦100λf/L
wherein d represents the width of the reflecting track, λ represents the wavelength of the light irradiated from the light source, f represents the focal distance of the objective lens, and L represents the width of the spatial modulator in a direction perpendicular to the optical axis of the signal light.

When the width of the belt-form reflecting track is in the given range as described above, only light components necessary for recording information in the signal light can be irradiated, without excess or shortage, to the recording layer.

<3> The holographic recording medium of <2>, wherein the width d of the reflecting track is smaller than 10λf/L.

When the upper limit of the width of the belt-form reflecting track is further limited to the given value or less as described above, it is possible to prevent the zero order component of the signal light from leaking into the recording layer.

<4> A holographic recording process using a holographic recording medium comprising a recording layer in which information is recorded by irradiating a signal light and a reference light simultaneously to the layer, and a reflecting track on which a servo signal light is reflected, the reflecting track being formed on or above a recording layer surface to which the signal light is irradiated,

wherein the optical axis of the signal light and that of the reference light are perpendicular to the reflecting surface of the reflecting track and are coaxially positioned, and a zero order light component of the signal light is used as the servo signal light.

When the optical axis of the signal light and that of the reference light are perpendicular to the reflecting surface of the reflecting track in the holographic recording medium and are coaxially positioned as described above, the optical axis of the light irradiated to the recording layer and the optical axis of the light reflected on the reflecting track are wholly positioned on the same axis. It is therefore unnecessary to arrange optical members such as a lens, or optical elements such as a CCD camera, for each optical axis of lights having different functions or roles.

As described above, according to the invention, there can be provided a holographic recording medium by which (1) a light source that is exclusively for servo control can be made unnecessary in a apparatus used to record or reproduce information in the case of performing servo control using a zero order light component of a signal light and (2), in a case of a reflective recording medium, noise resulting from irregular reflection on its reflective layer can be restrained even if a wavelength-selecting layer is not formed; and a holographic recording process by which (3) it is possible to record or reproduce information by means of a recording and reproducing apparatus having a simpler structure than apparatuses in the prior art.

What is claimed is:

1. A holographic recording medium comprising a recording layer in which information is recorded by irradiating a signal light and a reference light simultaneously to the layer, and a reflecting track on which a servo signal light is reflected, the reflecting track being formed on or above a recording layer surface to which the signal light is irradiated.

2. The holographic recording medium of claim 1, further comprising a substrate, wherein the recording layer is formed on the substrate.

3. The holographic recording medium of claim 2, further comprising a reflective layer between the recording layer and the substrate.

4. The holographic recording medium of claim 2, further comprising a protective layer on the recording layer at the side opposite to the substrate side of the recording layer.

5. The holographic recording medium of claim 4, wherein the reflecting track is formed at an interface between the recording layer and the protective layer.

6. The holographic recording medium of claim 4, wherein the reflecting track is formed on the surface of the protective layer.

7. The holographic recording medium of claim 1, wherein the recording layer comprises a photorefractive material.

8. The holographic recording medium of claim 7, wherein the photorefractive material is an organic material containing a photoisomerizable group.

9. The holographic recording medium of claim 8, wherein the photorefractive material has an azobenzene skeleton.

10. The holographic recording medium of claim 7, wherein the recording layer further contains a binder resin.

11. The holographic recording medium of claim 1, wherein the thickness of the recording layer is from 3 to 100 μm.

12. The holographic recording medium of claim 1, wherein the thickness of the recording layer is from 100 μm to 2 mm.

13. The holographic recording medium of claim 1, wherein:
the information is recorded by use of an optical system comprising a light source that irradiates light, a spatial modulator that converts the light irradiated from the light source into at least the signal light, and an objective lens that converges and irradiates the signal light formed by the conversion through the spatial modulator so as to focus on the recording layer;
the spatial modulator and the objective lens are arranged in such a manner that the optical axis of the signal light at least between the objective lens and the recording layer is parallel to the thickness direction of the recording layer;
the reflecting track is formed in the form of a belt along the plane direction of the recording layer; and
the following expression (1) is satisfied:
(1):λ/2≦d≦100λf/L
wherein d represents the width of the reflecting track, λ represents the wavelength of the light irradiated from the light source, f represents the focal distance of the objective lens, and L represents the width of the spatial modulator in a direction perpendicular to the optical axis of the signal light.

14. The holographic recording medium of claim 13, wherein the width d of the reflecting track is smaller than 10λf/L.

15. A holographic recording process for recording information in the holographic recording medium of claim 1 by use of an optical system comprising a light source that irradiates light, a spatial modulator that converts the light irradiated from the light source into at least the signal light, and an objective lens that converges and irradiates the signal light formed by the conversion through the spatial modulator so as to focus on the recording layer, wherein
the spatial modulator and the objective lens are arranged in such a manner that the optical axis of the signal light at least between the objective lens and the recording layer is parallel to the thickness direction of the recording layer,
the reflecting track is formed in the form of a belt along the plane direction of the recording layer, and
the following expression (1) is satisfied:
(1):λ/2≦d≦100λf/L
wherein d represents the width of the reflecting track, λ represents the wavelength of the light irradiated from the light source, f represents the focal distance of the objective lens, and L represents the width of the spatial modulator in a direction perpendicular to the optical axis of the signal light.

16. The holographic recording process of claim 15, wherein the width d of the reflecting track is smaller than 10λf/L.

17. A holographic recording process using a holographic recording medium comprising a recording layer in which information is recorded by irradiating a signal light and a reference light simultaneously to the layer, and a reflecting track on which a servo signal light is reflected, the reflecting track being formed on or above a recording layer surface to which the signal light is irradiated,
wherein the optical axis of the signal light and that of the reference light are perpendicular to the reflecting surface of the reflecting track and are coaxially positioned, and a zero order light component of the signal light is used as the servo signal light.
